(19) United States
(12) Patent Application Publication
(10) Pub. No.: US 2020/0293994 A1
(43) Pub. Date: Sep. 17, 2020

(54) RAPID ITEM DEVELOPMENT USING INTELLIGENT TEMPLATES TO EXPEDITE ITEM BANK EXPANSION

(71) Applicant: APICS, Inc., d/b/a ASCM, Chicago, IL (US)

(72) Inventors: Lisa Sallstrom, Indian Head Park, IL (US); Carolina Cruz, Chicago, IL (US); Gabriela Welch, Palatine, IL (US); Frank Perna, Harwood Heights, IL (US); Rachael Jin Bee Tan, Safety Harbor, FL (US)

(73) Assignee: APICS, Inc., d/b/a ASCM, Chicago, IL (US)

(21) Appl. No.: 16/815,937

(22) Filed: Mar. 11, 2020

Related U.S. Application Data
(60) Provisional application No. 62/816,588, filed on Mar. 11, 2019.

(51) Int. Cl. G06Q 10/10; G06F 17/18; G06Q 50/20; G06Q 10/06; G06Q 30/00

(52) U.S. Cl. CPC G06Q 10/101; G06F 17/18; G06Q 30/018; G06Q 10/067; G06Q 50/2057

(57) ABSTRACT

A system and method for rapidly developing items is presented. A root item is created or identified as a starting point for development of an item template. The item template is developed from the selected root item using a key calculation as well as calculations to generate distractors to ensure that an item discriminates well. The template identifies variables, provides the calculation and rationale for each answer option, and defines any variable constraints. Items are then cloned from the template. The cloned items may be identical in format to the root items. Finally, the statistical performance of the cloned item is verified by subjecting a few select cloned items to undergo an initial statistical analysis to validate the performance of a template and, once validated, multiple cloned items may be created and used in scored positions on future test administrations without needing to pretest.

### PRIORITY STATEMENT UNDER 35 U.S.C. § 119 & 37 C.F.R. § 1.78

This non-provisional application claims priority based upon prior U.S. Provisional Patent Application Ser. No. 62/816,588 filed Mar. 11, 2019, in the names of Lisa Sallstrom, Carolina Cruz, Gabriela Welch, Frank Perna, and Rachael Jin Bee Tan entitled “RAPID ITEM DEVELOPMENT USING INTELLIGENT TEMPLATES TO EXPEDITE ITEM BANK EXPANSION,” the disclosures of which are incorporated herein in their entirety by reference as if fully set forth herein.

### BACKGROUND OF THE INVENTION

When managing a certification program, it is considered good business practice to ensure the relevancy of content with respect to changing industry needs. According to a 2015 Financial Times article, “[w]e have no choice but to match our own pace of work to the demands of a superfast globalized business world”, argues Sir Martin Sorrell, Chief Executive of Marketing Services Group WWP. “You have to be responsive; you shouldn't attempt to fight it or slow the pace down.” In the certification business, market acceptance of a certification program may be tied to relevancy and, more specifically, how well the certification reflects current industry job requirements. Rate of change may certainly vary depending on industry. For example, to keep pace with technological innovation and advancement, technical certifications may require an annual or more frequent update while other industries may change at a slower pace.

Furthermore, a robust pool of test items increases test security and reduces the impact of a security breach because new items may be quickly substituted with minimal disruption to test administration. Organizations may also reduce item exposure by having more items from which to choose during test form development. Enhanced item development should also support certification business advancements such as adaptive testing, which requires at least three times as many items to test for miniscule variances in difficulty while covering the entire breadth and depth of the content outline. Enhanced item development also has the potential to reduce language translations costs because translation of one root item (template) may result in staff's ability to create many cloned items.

### Traditional Item Writing Processes

In many high-stakes certification programs, items are most frequently developed in one of two ways; conventional item writing workshops or contracting with expert item writers serving as consultants. Both processes have become industry standard for item development.

### Conventional Item Writing Workshops

In conventional face-to-face workshops, an organization will typically recruit a diverse group of eight or more subject matter experts and gather them all in one physical location. Over the course of a few days, this group will write and develop new, raw items for pretesting. The recruitment of subject matter experts requires an organization to reach out to its pool of certified/licensed individuals to search for volunteer item writers. These writers are often incentivized through a combination of professional development credit, honoraria, travel reimbursement, and/or networking opportunities. Item writing training which usually includes organizational style guide standards is delivered prior to the writing task, and an organization will typically involve more seasoned item-writing volunteers to work as coaches or mentors for newer, less-experienced writers. An advantage of this process is that all volunteers are in one place, lending itself to less distraction and more motivation to complete tasks, thereby developing many new items all at a given time. This process also serves as an opportunity for organizations to assess subject matter expert performance for future volunteer engagement opportunities.

While face-to-face item writing workshops are the most common strategy for new item development, there are certainly constraints that are associated with the process. For example, availability of volunteers is a big concern. According to an article that appeared in The NonProfit Times, volunteering is at a 10-year low. Volunteers' time has become increasingly scarce and it has become more and more difficult to engage volunteers for item writing. While selecting a convenient date and time for volunteers to attend a multi-day meeting may be a challenge, cost is also a significant consideration. In addition to the inherent cost of meeting logistics (travel, food, meeting space, etc.), there is the cost of staff time and resources required to oversee this process.

### Contracted Item-Writing Experts

A common alternative to conducting in-person workshops is for organizations to hire one or more external subject matter expert contractors to write new items. Expectations, payment and terms are detailed in a contract along with requested number of items and the associated content domains. This option is usually chosen for item development throughput expediency (conversion to scored items) which allows the test development committee to focus on form content quality and review. Contracting is also a good option for organizations who lack resources to manage face-to-face item writing workshops.

However, when using contractors, it may be difficult to identify subject matter experts who are able and willing to write the number of items needed within the specified time. As a workaround, organizations may choose to contract work out to a test development and/or administration vendor, which may be very costly and unsustainable in the long term. Traditional item writing processes demand a significant amount of organizational resources which is ripe for innovative advances in the approach.

With either the face-to-face workshop or contracted item writing, all newly-written items must go through a pretesting process to ensure they are psychometrically valid before becoming operational as a scored item. This is a lengthy process which usually takes anywhere from 12-24 months which largely depends on test volume and delivery processes to generate the minimum number of required item exposures for psychometric validity.

### Innovative Item Writing Processes

Automated item generation (AIG) is a relatively new process that organizations are exploring to mass generate test items with the assistance of computer technology. This process typically requires subject matter experts to create complex cognitive models that are used to develop item templates from which dozens, sometimes even hundreds, of items may be produced. Since this process is very different from traditional item writing methods, staff and subject matter experts must be trained in developing a cognitive modeling procedure and how to use specialized software to generate cloned items. Often AIG software must be purchased or licensed, but in some cases, organizations choose to create and maintain proprietary AIG software, which results in additional overhead costs. Furthermore, items generated by AIG still require a pretest period to validate statistics prior to converting them to scored. Therefore, this procedure may exponentially generate a large number of items but is still constrained by a lengthy pretest timeline.

There is a need, therefore, for a systematic approach to item cloning to quickly augment the item pool, wherein once a process is established to ensure psychometric viability, new items may be automatically generated with little effort via a tested item template. The methods and systems disclosed and claimed herein capitalize on the advantages of cloning process that overcomes the need for any pretesting required to develop scored items.

### SUMMARY OF THE INVENTION

The present invention relates to a system and method for rapidly developing items using intelligent templates to expedite item bank expansion. More specifically, a root item is first created or identified which provides the starting point for development of an item template. A non-exclusive list of criteria are presented for identifying a root item, such as ensuring that the item is relevant to the test body of knowledge, aligns with the test blueprint and provides value to the content being tested. As will be apparent, the selection of a pre-existing scored item from the item pool has several advantages, including style guide adherence, linkages to the test content outline, and previously-validated psychometric statistics.

Next, a template is developed from the selected root item using a key calculation as well as calculations to generate the remaining plausible distractors to help ensure that an item discriminates well, and that test-savvy candidates are not able to guess the correct answer solely by process of elimination. The template should identify the variables, provide the calculation and rationale for each answer option, and define any variable constraints.

Once the template has been created, items are cloned from the template. The cloned items may be identical in format, with the only changes made being to the various item variables. The pre-determined variable constraints may be mandated to ensure that all aspects of the new item remain plausible since even small changes to the template's language, format or presentation may result in variability in the statistical performance of cloned items.

Finally, the statistical performance of the cloned item is verified. Typically, a few select cloned items should undergo an initial statistical analysis to validate the performance of a template. Once the performance of a template item is validated, multiple cloned items may be created and used in scored positions on future test administrations without needing to pretest.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### DESCRIPTION OF THE DRAWINGS

For a more complete understanding of the present invention, and the advantages thereof, reference is now made to the following descriptions taken in conjunction with the accompanying drawings, in which:

FIG. 1 depicts an example root item on the Cost of Goods Sold (COGS) concept in one embodiment of the invention;

FIG. 2 depicts a template developed from the root item in FIG. 1; and

FIG. 3 depicts an cloned item created from the template in FIG. 2.

### DESCRIPTION OF THE PREFERRED EMBODIMENTS

The present invention is directed to improved methods and systems for, among other things, expediting item development. The configuration and use of the presently preferred embodiments are discussed in detail below. It should be appreciated, however, that the present invention provides many applicable inventive concepts that may be embodied in a wide variety of contexts other than test item generation. Accordingly, the specific embodiments discussed are merely illustrative of specific ways to make and use the invention, and do not limit the scope of the invention. In addition, the following terms shall have the associated meaning when used herein:

“item” means any item used in testing such as, for example, multiple choice, true-false, matching, completion, or essay questions; and

“test” means any test or examination that includes items, such as a certification test, standardized test or other examination.

For almost all organizations, an increase in item production directly corresponds to an increase in test development costs. Depending on the item writing process followed, the overhead cost of developing one, statistically-verified, scored item may range from several hundred dollars to several thousand dollars. And to achieve scored status, new items require pretesting which involves statistical validation and management of test publishing cycles and pretest tails/unscored item sets to obtain maximum throughput. The methods and systems of the present invention may help eliminate the need to repeat pretesting for variations on a specific topic or methodology, which increases opportunities to pretest different item types and levels of thinking.

Embodiments of the present invention include a strategic approach to quickly develop new items that do not have to undergo the pretest process before being used in scored positions on an exam. This reduces test development costs, keeps test content current and increases test security. In addition, the ramp up of test items and a growing item bank will allow organizations to expand their testing windows, even as far as expanding to on demand testing. This is a significant benefit to the organization as well as to candidates. With on demand testing, candidates will have the flexibility of testing on their schedule, without missing the opportunity to test, or re-study if they missed set windows. In addition, on demand testing allows an opportunity for more frequent statistical analysis, approval of statistically valid test items, decreased risk of item exposure, among the many benefits.

The goals of credentialing organizations may differ quite drastically, but the need for item growth is something that is shared industry-wide. Embodiments of the present invention present a viable, statistically-valid means for achieving this growth while meeting ever-changing business needs and achieving a number of strategic business goals including strengthening test security, decreasing long-term item development costs and maximizing volunteer efficiency. Through the use of templates, key concepts and content areas may be introduced more quickly and tested more efficiently to allow organizations to accurately assess candidate ability in an accelerated business environment.

Various embodiments of the present invention involve a four-step process that includes: 1) identifying or creating a root item; 2) developing a template from that root item; 3) using the template to clone additional items; and 4) conducting statistical validation of the cloned additional items. Once these processes have been completed, new items may be created from the template without the need for further pretesting. These processes are described in more detail below, walking through the process from the formation of a root item through the statistical vetting of cloned items.

### Step 1: Identify or Create a Root Item

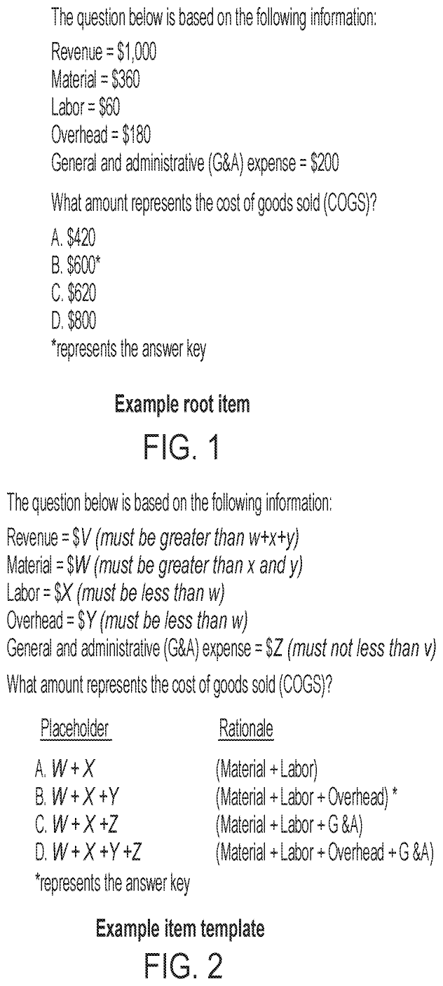

Embodiments of the present invention commence with the creation or identification of a root item which provides the starting point for development of the item template. A non-exclusive list of criteria are listed below for identifying a root item:
1) Ensure that the item is relevant to the test body of knowledge, aligns with the test blueprint and provides value to the content being tested;
2) Maintain pre-established organization guidelines for item writing style.
3) Provide many different variables that may be manipulated to create a dynamic template from which many item cloned items may be generated. For example, there may be many items that present numerical inputs to use for calculation purposes. These numerical inputs are used to create formulas for the key and each plausible distractor. Referring to FIG. 1 which is an example root item on the Cost of Goods Sold (COGS) concept in which the root item shown illustrates the importance of the variety in numerical inputs.

The selection of a pre-existing scored item from the item pool has several advantages, including style guide adherence, linkages to the test content outline, and previously-validated psychometric statistics. Those skilled in the art will appreciate that, when selecting an existing item, one may choose an item that met psychometric standards during its most recent administration.

Step 2: Develop a Template from the Root Item

To develop a template from the root item, the key calculation must be known as well as calculations to generate all the remaining plausible distractors to help ensure that an item discriminates well, and that test-savvy candidates are not able to guess the correct answer solely by process of elimination. For example, if there are only two ways to manipulate the variable in the item stem, the root item is too easy because more than one distractor will be implausible and may be quickly eliminated as incorrect.

The template should identify the variables, provide the calculation and rationale for each answer option, (i.e. key and distractors), and define any variable constraints. Variable constraints help ensure distractors are plausible and the item stem provides realistic information. If computer software is used, constraints are required to define the range of potential values for each variable. If subject matter experts are asked to clone items from a template, variable constraints promote standardization and provide additional quality control. Referring now to FIG. 2 which shows a template developed from the root item in FIG. 1. In this example, the constraints that must be followed are listed with each variable to ensure that plausibility is maintained. The placeholder shows the variable combination used to calculate each answer option.

Step 3: Clone Items from Template

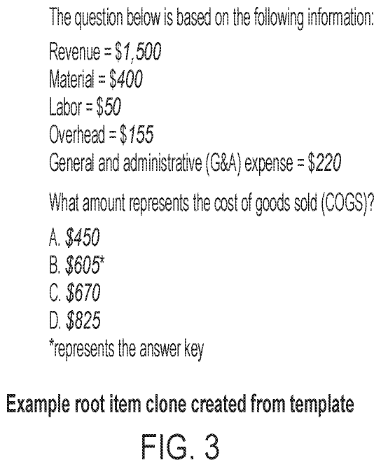

Using an established template, one may create multiple cloned items. Cloned items should be identical in format to the root items, with the only changes made being to the different item variables. In many embodiments, it is important to adhere to the pre-determined variable constraints to ensure that all aspects of the new item remain plausible. Even small changes to the template's language, format or presentation may result in variability in the statistical performance of the cloned item. Those skilled in the art will appreciate the importance of adhering to the item template. FIG. 3 shows an cloned item that was created from the template in FIG. 2.

### Step 4: Verify Statistical Performance of Cloned Items

As with any newly-developed item, a select few cloned items should undergo an initial statistical analysis to validate the performance of a template. However, once the performance of a template item is validated, multiple cloned items may be created and used in scored positions on future test administrations without needing to pretest. Approved item templates are those whose cloned items perform within a psychometrically acceptable range to the root item on multiple statistical measures. In some embodiments, the performance of at least three cloned items may be verified before approving the use of a template for mass item generation. These three cloned items may be referred to as the beta clones, with subsequent cloned items becoming immediately operational after successful performance of the beta clones have been verified.

To establish a consistent testing environment, organizations may administer the beta clones concurrently using multiple pretest tails/sets on the same or parallel base forms. This data collection design helps protect against sample changes and other sources of variance that may be introduced over time. If concurrent testing is not possible, it may be desirable to develop an individualized plan for administering at least three beta clones, from the same item template, during a reasonable timeframe.

The statistical performance of beta clones may be verified by having a large enough sample size to draw defensible conclusions when interpreting pretest results. In some of the embodiments, each of the beta clones must be administered to an adequate sample of candidates before making statistical comparisons of performance across the cloned items and root item. These exams typically have a relatively high candidate volume, which permits the use of item response theory (IRT) scoring. IRT is a powerful statistical model that allows for sample-independent comparisons of candidate and item performance. To maintain a stable IRT scoring scale, a minimum of 300 candidate responses to each pretest item is collected before running statistical analyses on examination data.

Approving an item template occurs by comparing the actual and predicted performance of the beta clones on, for example, three statistical indices. When three indices are used, the first index may be the IRT item difficulty, or b parameter. In general, item difficulty values for an test range from −4 to +4 logits, with higher values indicating more difficult items. In addition to judging cloned item performance by the IRT b parameter, it also compares cloned item performance using classical test theory (CTT) statistics. Unlike IRT parameters, CTT statistics are sample-dependent and vary depending on the proficiency level of the candidates taking the exam. An item's CTT difficulty value (p-value) reflects the proportion of candidates who answered the item correctly on a single test form during a specific administration window. An item's p-value is 0 if no candidates answered the item correctly, and 1 if all candidates answered it correctly.

The second CTT index may be an item's discrimination value, which represents the correlation between item and test performance. The system measures item discrimination using the point-biserial correlation coefficient. Discrimination values range from −1 to +1. A +1 occurs when all high performers (large total test score) answer an item correctly and all low performers (small total test score) respond incorrectly. The inverse results in a discrimination of −1. Larger discrimination values are desirable because they indicate a strong, positive relationship between answering an item correctly and performing well on the examination.

What constitutes similar item performance across the three indices may be determined by the organization and may be based on existing psychometric/statistical guidelines and thresholds used in decision making, such as those used when assessing item quality. In one embodiment, the system of the present invention uses the following guidelines to help determine whether the beta clones and root item are performing similarly:
The p-values should be within +/−0.10 of each other
The discrimination statistics should be within +/−0.15 of each other
The IRT b values should be within +/−0.60 logits of each other

Among all three statistics, one embodiment of the present invention relies most heavily on the IRT difficulty value to determine whether to approve an item template. For the IRT difficulty value, similar performance is achieved if the absolute value of the displacement statistic (difference between the actual and predicted difficulty of the item) is less than 0.60 logits. This is the same threshold that may be used when evaluating item performance to decide when to “unanchor” a scored item's difficulty parameter when calibrating pretest items. It may not be desirable to adopt these thresholds without considering their existing psychometric guidelines for assessing item quality. An organization's psychometric staff or qualified consultants should be involved when deciding the most defensible option for assessing cloned item performance and approving templates for mass item generation without pretesting.

In an exemplary embodiment, a computerized method for expanding an item bank is presented in which a root item is identified for use as a starting point for developing an item template, wherein the item template identifies variables, provides a calculation and rationale for each answer option, and defines any variable constraints. Cloned items are then created from the item template, wherein the cloned items are identical in format to the root item. Statistical performance of the cloned items is verified by subjecting three or more cloned items to statistical analysis to validate performance of the item template. Once validated, a plurality of cloned items are created for expanding an item bank.

In this embodiment, the root item is selected because it met psychometric standards during the root item's most recent administration. The item template may be developed from the root item using a key calculation as well as calculations to generate distractors to ensure that an item discriminates well. The variable constraints define a range of potential values for each variable. The plurality of cloned items may be used without pretesting, Item response theory is used for verification. The statistical performance of the three or more cloned items is determined by whether p-values of the root item and the three or more cloned items are within +/−0.10 of each other, or the statistical performance of the three or more cloned items is determined by whether discrimination statistics of the root item and the three or more cloned items are within +/−0.15 of each other, or the statistical performance of the three or more cloned items is determined by whether IRT b values of the root item and the three or more cloned items are within +/−0.60 logits of each other. Items from the item bank may be used in a certification examination, and the certification examination may be presented to a user seeking certification.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of methods for item development known in the art, the detailed embodiments are intended to be illustrative only and should not be taken as limiting the scope of the invention. Rather, what is claimed as the invention is all such modifications as may come within the spirit and scope of the claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

To aid the Patent Office and any readers of any patent issued on this application in interpreting the claims appended hereto, the applicant wishes to note that it does not intend any of the appended claims or claim elements to invoke 35 U.S.C. 112(f) unless the words “means for” or “step for” are explicitly used in the particular claim.

We claim:

1. A computerized method for expanding an item bank, comprising:
identifying a root item for use as a starting point for developing an item template, wherein the item template identifies variables, provides a calculation and rationale for each answer option, and defines any variable constraints;
creating cloned items from the item template, wherein the cloned items are identical in format to the root item;
verifying statistical performance of the cloned items by subjecting three or more cloned items to statistical analysis to validate performance of the item template; and
once validated, creating a plurality of cloned items for expanding an item bank.

2. The computerized method for expanding an item bank of claim 1, wherein items from the item bank are used in a certification examination.

3. The computerized method for expanding an item bank of claim 2, wherein the certification examination is presented to a user seeking certification.

4. The computerized method for expanding an item bank of claim 1, wherein the item template is developed from the root item using a key calculation as well as calculations to generate distractors to ensure that an item discriminates well.

5. The computerized method for expanding an item bank of claim 1, wherein the root item is selected because it met psychometric standards during the root item's most recent administration.

6. The computerized method for expanding an item bank of claim 1, wherein the variable constraints define a range of potential values for each variable.

7. The computerized method for expanding an item bank of claim 1, wherein the plurality of cloned items may be used without pretesting.

8. The computerized method for expanding an item bank of claim 1, wherein item response theory is used for verification.

9. The computerized method for expanding an item bank of claim 1, wherein the statistical performance of the three or more cloned items is determined by whether p-values of the root item and the three or more cloned items are within +/−0.10 of each other.

10. The computerized method for expanding an item bank of claim 1, wherein the statistical performance of the three or more cloned items is determined by whether discrimination statistics of the root item and the three or more cloned items are within +/−0.15 of each other.

11. The computerized method for expanding an item bank of claim 1, wherein the statistical performance of the three or more cloned items is determined by whether IRT b values of the root item and the three or more cloned items are within +/−0.60 logits of each other.
